(19) United States
(12) Patent Application Publication
(10) Pub. No.: US 2006/0180603 A1
(43) Pub. Date: Aug. 17, 2006

(54) Theft deterrent dispensing device and related method

(75) Inventor: Michael P. Eckert, Lake Bluff, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Design Phase, Inc., Waukegan, IL (US)

(21) Appl. No.: 11/059,273

(22) Filed: Feb. 16, 2005

(51) Int. Cl. B65G 59/00; G07F 11/16

(52) U.S. Cl. 221/279; 211/59.3

(57) ABSTRACT

A display and dispensing device including a dispensing end, and a rearward end for a product having a predetermined height and thickness, the device comprising: a base member extending between the dispensing end and the rearward end, the base member including an upward projecting product stop at the dispensing end the base member further including a notch disposed therethrough proximate the dispensing end to facilitate product removal by a purchaser; a ceiling member including a ceiling panel above the base member, the ceiling panel and base member defining a path between the dispensing end and the rearward end for lateral product movement; and a biasing mechanism biased toward the dispensing end, the biasing mechanism biasing a product within the device against an inner surface of the product stop; wherein the distance between the ceiling member and base member defines a clearance which is sufficient to permit the product to traverse the stop when the product is moved vertically within the device, thereby allowing the product to be removed from the device.

### FIELD OF THE INVENTION

This invention pertains generally to product dispensers and, more particularly, to devices for displaying and dispensing packaged products and goods in retail stores and methods of using such dispensers.

### BACKGROUND OF THE INVENTION

In retailing consumer products, it is often desirable to store and display a relatively large number of packaged products or goods in a manner that promotes consumer awareness and ease of selection. Traditionally, retailers have accommodated consumers by providing aisles bordered by vertically-arranged horizontal shelving on which various packaged products or goods are presented for sale. Some retailers also installed devices on the shelves which assist in retaining the packaged product in its proper location on the shelving, e.g., vertical plastic or wire mesh side walls, with some further installing a component that constantly pushes product located within the side walls toward the front of the shelving. This arrangement of aisles and shelving provides consumers with product awareness and relatively easy access to products and goods, and further allows for the efficient utilization of retail space by maximizing the volume of products stored per unit area of floor space.

While existing horizontal shelving provides consumer access and efficient product storage, it provides virtually no deterrent to shoplifting. Most shelving systems permit a person to quickly remove a relatively large quantity of packaged products from a shelf at one time, allowing a would-be thief to quickly and efficiently clear a shelf of a particular product. Product theft of this type has become particularly acute in the area of over-the-counter pharmaceuticals, as this product category includes relatively high margin items packaged in relatively small containers.

Thus, a need exits for product display and storage devices and related methods that are suitable for a use in a retail environment-meeting the needs of consumers and retailers while overcoming the problems inherent in existing shelving systems and devices.

### BRIEF SUMMARY OF THE INVENTION

In a first embodiment, the present invention provides a display and dispensing device including a dispensing end, and a rearward end for a product having a predetermined height and thickness, the device comprising: a base member extending between the dispensing end and the rearward end, the base member including an upward projecting product stop at the dispensing end the base member further including a notch disposed therethrough proximate the dispensing end to facilitate product removal by a purchaser; a ceiling member including a ceiling panel above the base member, the ceiling panel and base member defining a path between the dispensing end and the rearward end for lateral product movement; and a biasing mechanism biased toward the dispensing end, the biasing mechanism biasing a product within the device against an inner surface of the product stop; wherein the distance between the ceiling member and base member defines a clearance which is sufficient to permit the product to traverse the stop when the product is moved vertically within the device, thereby allowing the product to be removed from the device.

Another embodiment of the present invention contemplates a display and dispensing device including a dispensing end and a rearward end for a product having a predetermined height and thickness, the device comprising: a base member extending between the dispensing end and the rearward end, the base member including an upward projecting product stop at the dispensing end; a ceiling member including a ceiling panel above the base member and a canopy located at the dispensing end which includes first and second edges, the first edge being joined to the ceiling panel rearward of the product stop and the second edge located forward of the product stop, wherein the ceiling panel and base member define a path between the dispensing end and the rearward end for lateral product movement; and a biasing mechanism biased toward the dispensing end, the biasing mechanism biasing a product within the device against an inner surface of the product stop; wherein the canopy provides a clearance above the product stop, the clearance being sufficient to permit the product to traverse the product stop when the product is moved vertically within the clearance, thereby allowing the product to be removed from the device.

Yet another embodiment of the present invention provides a device for dispensing and displaying a package product comprising: a base member having a dispensing end and an opposite rearward end, the base member including an upward projecting product stop at the dispensing end; a ceiling member above the base member, the ceiling member extending at least coextensive with an inner surface of the product stop, wherein the base member and ceiling member are arranged to define a clearance above the product stop that is sufficient to permit the product to traverse the stop when the product is moved vertically within the device, thereby allowing the product to be removed from the device.

In another embodiment, the present invention provides a stack for dispensing and displaying a packaged product having a predetermined height and thickness, the stack comprising: a plurality of trays arranged generally vertically in the stack, each tray comprising a dispensing end, an opposite rearward end, a base member having an upper surface and a lower surface, and a product stop projecting upward from the upper surface of the base member proximate to the dispensing end, the plurality of trays arranged so that the upper base member surface of a first tray is spaced below the lower base member surface of a second tray to provide a path for lateral movement of a product, the distance between the upper base member surface of the first tray and the lower base member surface of the second tray being selected to provide clearance sufficient to permit the product to traverse the product stop when the product is moved vertically within the tray, thereby allowing the product to be removed from the stack.

The present invention further provides a stack for dispensing and displaying a packaged product having a predetermined height and thickness, the stack comprising: a plurality of trays arranged generally vertically in the stack, each tray comprising a dispensing end, an opposite rearward end, a base member having an upper surface and a lower surface, the lower base member surface including an embossment, and a product stop projecting upward from the upper surface of the base member proximate to the dispensing end, the plurality of trays arranged so that the upper base member surface of a first tray is spaced below the lower base member surface of a second tray to provide a path for lateral movement of a product, the distance between the upper base member surface of the first tray and the lower base surface of the second tray being selected to provide clearance sufficient to permit the product to traverse the product stop when the product is moved vertically within the tray, thereby allowing the product to be removed from the stack, the plurality of trays further arranged so that the lower base member surface extends at least coextensively with an inner surface of the product stop and the embossment is located rearward of the inner surface of the product stop to define the path.

In yet another embodiment, the present invention contemplates a stand for displaying and dispensing a product having a predetermined height and thickness, the cube comprising: a plurality of generally vertical stacks, each stack including a plurality of trays each comprising a dispensing end, an opposite rearward end, a base member having an upper surface and an lower surface, and a product stop projecting upward from the upper surface of the base member proximate the dispensing end, the plurality of trays arranged in the stacks so that the upper base member surface of a first tray is spaced-below the lower base member surface of a second tray to provide a path for lateral movement of a product, the distance between the upper base member surface of the first tray and the lower base member surface of the second tray being selected to provide clearance sufficient to permit the product to traverse the product stop when the product is moved vertically within the tray, thereby allowing the product to be removed from the stand.

The present invention also provides methods for using the aforesaid devices for dispensing packaged products. By way of example, one embodiment of the present invention provides a method for dispensing a packaged product having a predetermined height and thickness, the method comprising: providing a device including a base member and an opposing ceiling member extending between a dispensing end and a rearward end, the base member having an upward projecting product stop at the dispensing end, and the ceiling member having a ceiling panel and a canopy portion, the canopy portion extending at least coextensive with the product stop; laterally biasing a packaged product located between the base member and the ceiling member against an inner surface of the product stop; vertically moving a packaged product into a clearance provided by the canopy portion of the ceiling member, wherein the clearance is sufficient to permit the product to traverse the product stop when so moved; and removing the packaged product from the device.

The foregoing and other features of the present invention will be apparent from the detailed description and the accompanying drawings.

### BRIEF DESCRIPTION OF THE DRAWINGS

The accompanying drawings are incorporated into and form a part of the specification. In the drawings:

FIG. 1 is a top perspective view of one embodiment of the inventive dispensing device for packaged products.

FIG. 2 is a side elevational view of the dispensing device of FIG. 1 illustrating a product positioned at the dispensing end of the device, with a base member and a ceiling member of the device being adjusted to minimize the distance therebetween.

FIG. 3 is a front elevational view of the dispensing end of the dispensing device of FIG. 1 illustrating in cut away an engagement between a biasing mechanism and the base member.

FIG. 4 is a bottom plan view of the base member of the dispensing device of FIG. 1 illustrating a notch disposed therethrough.

FIG. 5 is a side elevation view of the dispensing device of FIG. 1 illustrating a product positioned proximate the rearward end of the device, with the base member and ceiling member of the device being adjusted to maximize the distance therebetween.

FIG. 6 is a top perspective view of another embodiment of the inventive dispensing device which includes first and second sidewalls to further assist in restricting premature access to the products to be dispensed.

FIG. 7 is a top perspective view of another embodiment of the inventive dispensing device wherein the dispensing device is configured as an upright, optionally rotatable, stand comprising five vertical stacks, each stack consisting of four trays.

FIG. 8 is an exploded view of the stand of FIG. 7.

FIG. 9 is a front elevational view of the stand of FIG. 7.

FIG. 10 is a top perspective partial view of the stand of FIG. 7, wherein two sets of vertically-arranged trays are illustrated, one tray having packaged product located therein (in phantom).

FIG. 11 is a side view of the lower trays illustrated in FIG. 10, with packaged product located therein (in phantom).

FIG. 12 is a top perspective view of a tray illustrated in FIG. 11.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

The present invention provides, in one embodiment, a device for dispensing packaged products, preferably in a retail environment. This embodiment comprises a base member having a dispensing end and an opposite rearward end, with the base member including an upward projecting product stop at the dispensing end. The device further includes a ceiling member located above the base member, the ceiling member extending so that it is at least coextensive with an inner surface of the product stop. The base member and ceiling member are further arranged to define a clearance above the product stop that is sufficient to permit the product to traverse the stop when the product is moved vertically within the device, thereby allowing the product to be removed from the device.

The packaged products desirably dispensed in connection with this embodiment, and the other embodiments of the present invention, may typically comprise products packaged within cardstock boxes or plastic containers of predetermined sizes, preferably with a square or rectangular cross-section. Illustrative examples of such packaged products include, without limitation, medicines (e.g., cold remedies, laxatives, decongestants), pre-packed dry foods, DVD's, compact disks, and cigarettes.

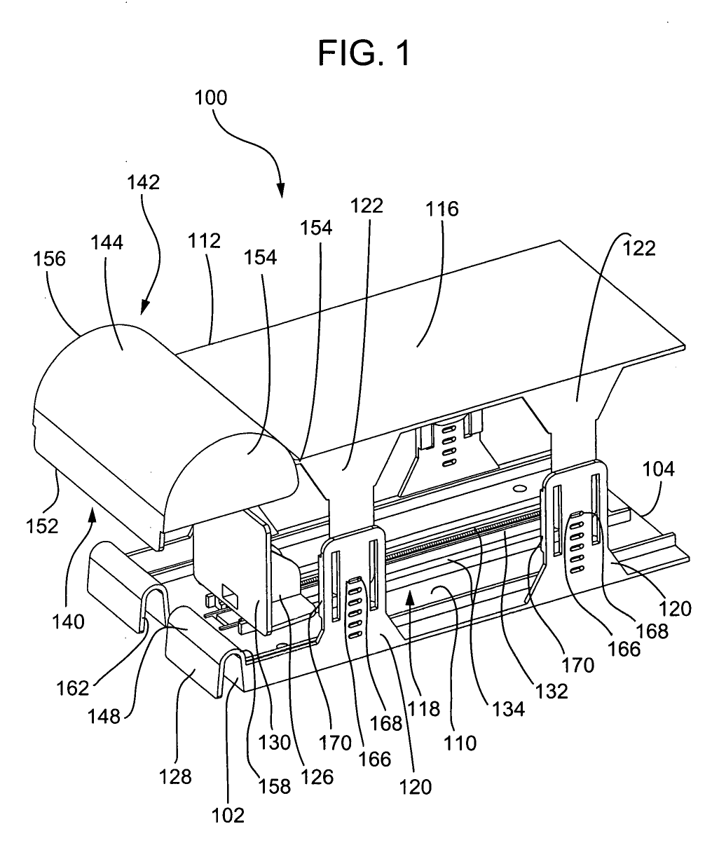

Turning now to the drawings, FIGS. 1-4 illustrate an embodiment of the device of the present invention. To accommodate packaged products, the dispensing device 100 includes an elongated body extending between a dispensing end 102 and an opposed rearward end 104. As used herein in connection with describing the dispensing devices of the present invention, the terms “forward” and “rearward” are relative, intended to provide orientation with respect to the end from which the packaged product may be dispensed by a consumer and an opposite end, respectively, and are not to be construed as additional limitations of the present invention. The body of the dispenser further includes a lower base member 110 and a ceiling member 112, the latter including a planar, and desirably square or rectangular, ceiling panel 116 situated above the base member. Again, the use herein of terms such as “lower,” “upper,” “above” and “below” are intended to provide vertical orientation with respect to the device described herein, and are not to be construed as additional limitations of the present invention. The base member 110 may be placed on top of a horizontal surface, e.g., a shelf in a retail store, and may include downward projecting foot pads 114 to assist in this placement.

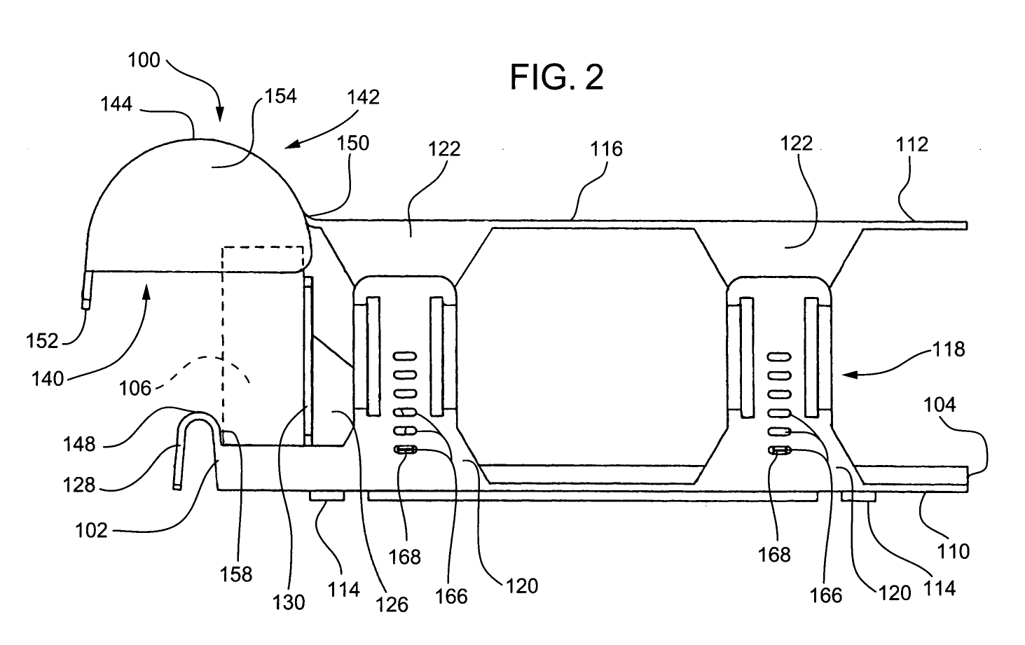

The base member 110 and ceiling member 112 are spaced apart from each other, desirably in a parallel relationship with one another, and define a path 118 that extends between the dispensing end 102 and the rearward end 104. A plurality of packaged products may be received in the path 118, between the base member 110 and the ceiling member 112, arranged in a back-to-front row. When in the device, the packaged products are biased toward the dispensing end 102 by a biasing mechanism 126 while supported by the base member 110. As illustrated in FIG. 2, to accommodate the packaged products, and to permit movement of the packaged products within the device, the vertical height of the path 118 between the base member 110 and the ceiling panel 116 should be at least the same as, and desirably slightly greater than, the predetermined height of the product. Preferably, the vertical height of the path should exceed the package height by about ⅛ to about 12 inch, or more.

In the embodiments disclosed herein, the base member and ceiling member are desirably comprised of a transparent thermoplastic or thermoset material to permit ease of manufacture to maximize product visibility.

The base member 110 and ceiling member 112 are desirably joined together by at least one side wall, and preferably two sidewalls, located therebetween. Each sidewall may comprise at least one set, and desirably a plurality of, sets, of interlocking uprights and legs, e.g., indicia 120 and 122 in FIG. 2, respectively. More desirably, at least two sets and, preferably, at least four sets, the latter as shown in FIG. 2, are included in a device. In a preferred embodiment, the uprights 120 may extend upward from the side edges of the base member and engage a corresponding plurality of legs extending downward form the ceiling panel 116. The side walls are preferably adapted to permit the packaged product removal only through the dispensing end of the device.

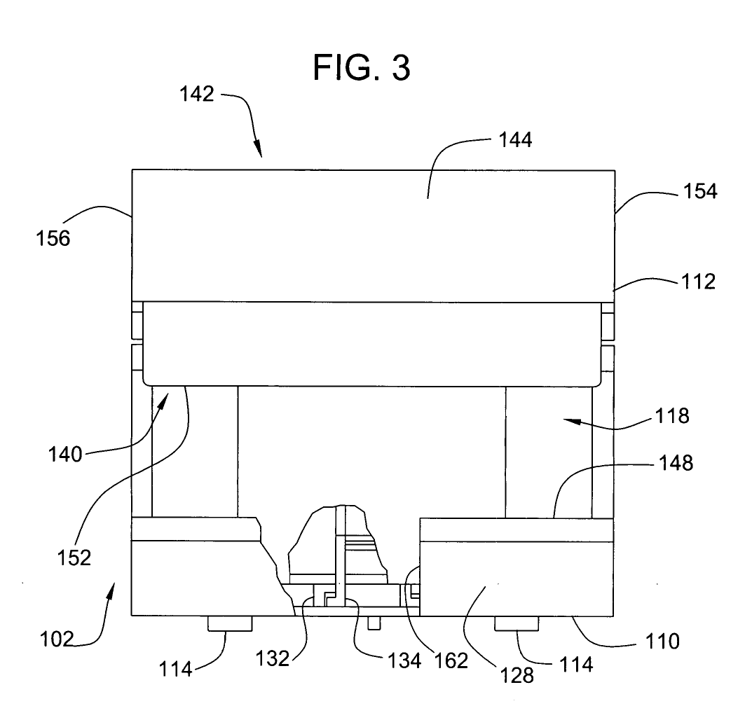

The biasing mechanism 126 assists in maintaining packaged products at the dispensing end 102 of the device. While this mechanism may function to urge the packaged products along the path toward the dispensing end, this forward movement of the products is preferably limited by an upward projecting product stop 128 included at the dispensing end 102 of the base member 110. In the embodiment illustrated in FIG. 1, for example, the biasing mechanism 126 includes a square or rectangular biasing plate 130 arranged generally perpendicular to and extending upward from the base member 110. The biasing plate 130 is reciprocally movable along the path 118 in a lateral direction between the dispensing end 102 and the rearward end 104. Providing the biasing force in this embodiment is a resilient spring 132 connected between the base member 110 and the biasing plate 130. To maintain alignment of the biasing plate 130 with respect to the path 118, the base member 102 desirably includes a set of elongated tracks 134 extending generally between the dispensing end 102 and the rearward end 104 of the device, with hook-like catches 136 (see FIG. 3) being desirably included on the biasing plate 130 for slidably engaging the tracks 134.

Referring to FIGS. 1 and 2, the base member 110 and ceiling member 112 are configured to limit the number of packaged products that may be removed from the dispensing device 100 by a consumer at one time, i.e., in a single dispensing cycle. To this end, and by way of further explanation, the ceiling member desirably extends at least coextensively with the inner surface 158 of the product stop, and more desirably traversing the entire stop, with the base member 110 and ceiling member 112 being further preferably arranged to provide a clearance 140 above the product stop 128. The clearance 140 is sized so that only a desired (limited) number of packaged products located at the dispensing end 102 may traverse the product stop 128 at one time, thereby controlling the number of products that can be removed from the device by the consumer in a single dispensing cycle.

To provide the aforesaid clearance 140, and as illustrated in the embodiment of FIGS. 1, 2, and 3, the ceiling member 112 may preferably include a canopy 142 located generally at the dispensing end 102 of the device. The canopy desirably extends laterally across the path traversed by the packaged product within the device and, in the illustrated embodiment, includes a surface 144 that projects upward and generally away from the base member, extending over the product stop 128. The clearance 140 provided by the canopy 142 is desirably such that the vertical distance between a top surface 148 of the product stop 128 and the underside of the canopy 142 measured at the plane which intersects the canopy and product stop is at least equal to or, preferably greater than, the predetermined height of the packaged product 106. The canopy is preferably joined to the ceiling panel 116 rearward of the product stop 128 along a first edge 150, and may terminate forward of the product stop along a second edge 152. The second edge 152 and the top surface 148 of the product stop 128 desirably provide an opening, preferably a quadrilateral opening, through which the product can be viewed, although the second edge of the canopy 152 may also extend downward beyond the product stop to further assist in slowing product removal.

While the canopy may have a variety of configurations including, in cross-section, a generally square, rectangular or curved shape, the canopy is desirably curved, and is preferably semi-cylindrical or Quonset-shaped.

Additionally, the canopy 128 may include a first side panel 154 and a second side panel 156 joined along the opposing edges of the surface 144 as a further barrier to undesirable removal of the product from the device.

To dispense a product 106 (shown in phantom in FIG. 1) biased against an inner surface 158 of the product stop 128 at the dispensing end 102 of the device illustrated in FIG. 1, the product may be moved vertically between the first and second side panels 154, 156 and into the clearance 140 provided by the canopy 142. To limit the number of products 106 that can be dispensed by a consumer at one time, the lateral distance between the inner surface 158 of the product stop 128 and the first edge 150 of the canopy 142 is preferably no more than about twice the thickness of the package product, and desirably no more than about the thickness of the product (or 1-½ the product thickness). For example, and depending upon the thickness of the packages to be dispensed, the first edge 150 may be located between about ½ to about 3 inches rearward of the inner surface 158 of the product stop 128, with the second edge 152 extending forward of the product stop 128, e.g., between about ½ to about 3 inches. Thus, and desirably, no more than two products 106, and preferably only a single product, may be moved into the clearance 140 by a consumer at one time. Once in the clearance 140, the bottom of the product (or products if two products are to be dispensed) should be able to clear the top edge 148 of the product stop 128. This permits the balance of the product to be moved laterally forward so that it also traverses the stop, allowing the entire package to be removed from the dispensing device 100. The preferred curved surface 144 and optional first and second side panels 154, 156 assist in guiding the product 106 through the clearance 140 during the aforesaid vertical and lateral movement. When one (or other desired number) of packaged product is removed from the dispensing device 100 at the completion of the dispensing cycle, the biasing mechanism 126 laterally moves the next product in the row forward toward the dispensing end 102 of the device to await selection by a consumer.

Because only a limited number of products can be dispensed from the dispensing device 100 by a consumer during each dispensing cycle, it will be appreciated that the device hinders and/or deters theft. Furthermore, requiring a product to be moved both vertically and laterally complicates removal of the product from the device, and slows the rate at which products may be dispensed from the device. In addition, locating the path 118 between the base member 110 and ceiling panel 116 restricts access to the products received along the path, further deterring theft of the packaged products.

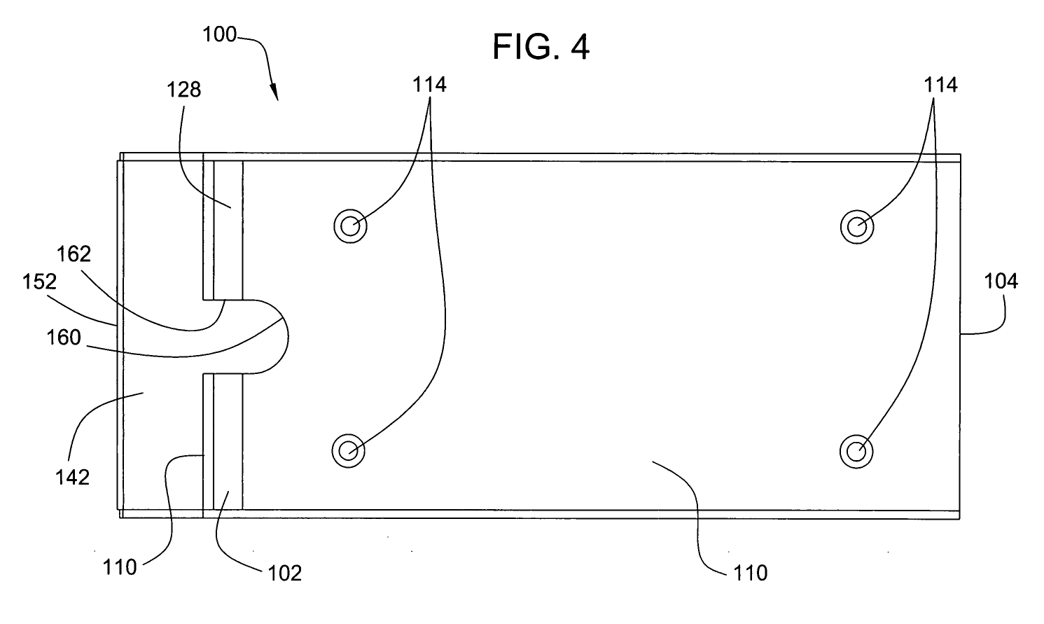

To facilitate vertical movement of the packaged product into the clearance 140, referring to FIG. 4, a notch 160 may be desirably disposed through the base member 110 proximate the dispending end 102. The notch 160 may be of any suitable size, but is preferably sized to allow a consumer to insert a finger through the base member 110 and push the product vertically upwards into the clearance 140. Furthermore, and as illustrated in FIGS. 1, 3, and 4, a slot 162 may, if desired, also be disposed through the middle of the product stop 128, this slot desirably intersecting the notch 160 in the base member 110. This intersection of the notch 160 and slot 162 enable a consumer to additionally move the product laterally forward to traverse the product stop 128.

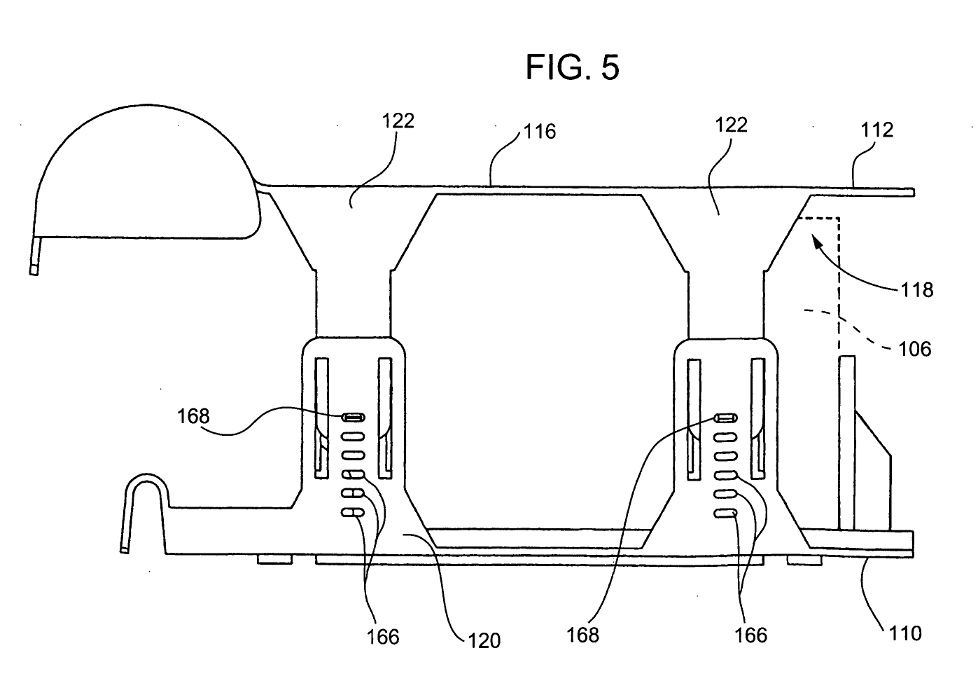

Referring to the embodiment shown in FIGS. 2 and 5, the device 100 may, if desired, also be adjusted to accommodate packaged products 106 of different predetermined heights. For example, disposed through the uprights 120 projecting from the sides of the base member 110 may be a plurality of vertically aligned apertures 166. For reception within the apertures 166, at least one correspondingly sized protrusion 168 projects outward from the side of the legs 122 that extend downward from the ceiling panel 116. In this configuration, when the leg 122 is resiliently pressed to flex into the path 118, the protrusion 168 is removed from the aperture 166, disengaging the upright 120 and leg, thereby allowing the vertical distance between the base member 110 and the ceiling member 112 to be adjusted. The protrusion 168 may then align with and be received in a different aperture 166 to reengage the upright 120 and leg 122. Because of the vertical arrangement of the plurality of apertures 166, the base member 110 and ceiling panel 116, and the distance between them, may be incrementally adjusted between a plurality of positions including a first position (illustrated in FIG. 2) wherein the vertical distance between the base member and ceiling panel is at a minimum and a second position (illustrated in FIG. 5) wherein the base member and ceiling panel is at a maximum. Referring to FIG. 1, to facilitate aligning the protrusion 168 and apertures 166, the upright 120 can include hooks 170 that extend on either side of the leg 122 allowing the leg to vertically slide with respect to the upright.

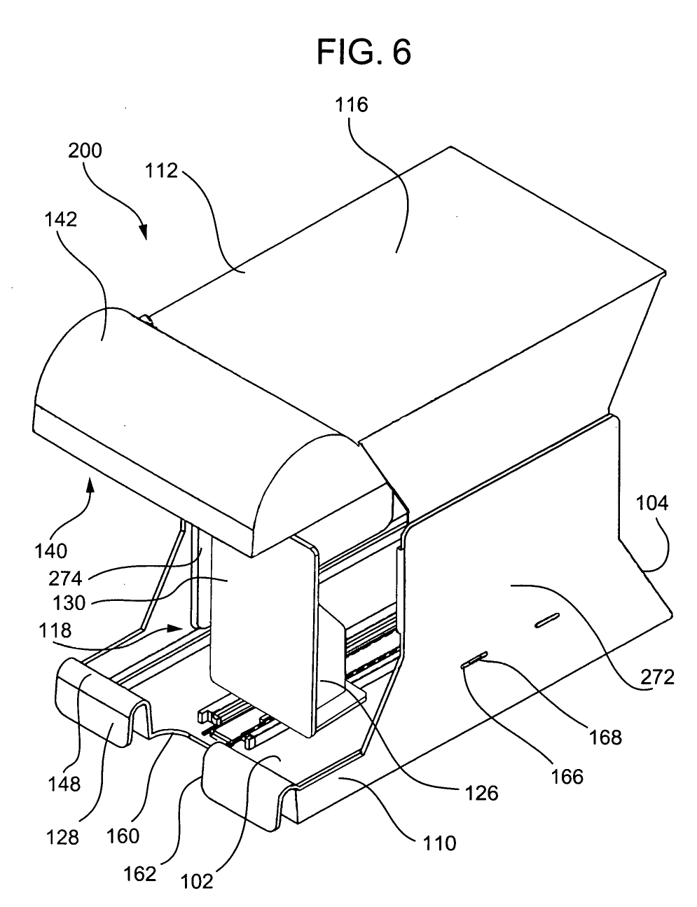

Referring to FIG. 6, there is illustrated an embodiment of a dispensing device related to the embodiment illustrated in FIG. 1-4. This related embodiment provides the same functionality and structures described in connection with the embodiment of FIGS. 1-4, while further including a relatively wide first sidewall 272 and second sidewall 274 which, desirably, extend substantially from the first edge of the canopy 142 to the rearward end 104 of the device to further enclose the product path 118. One or more apertures 166 may also be disposed through the sidewalls 272, 274, along with a correspondingly dimensioned protrusion 168, to permit adjustment of the vertical distance between the base member 112 and the ceiling panel 116. As described above, this permits the device to accommodate packaged products of varying predetermined heights.

The present invention also provides methods for using the aforesaid devices for dispensing packaged products. By way of example, one embodiment of the present invention provides a method for dispensing a packaged product having a predetermined height and thickness from a dispensing device, the method comprising: providing a dispensing device as described herein; laterally biasing a packaged product located between the base member and the ceiling member of the device against an inner surface of a product stop provided on the device; vertically moving a packaged product into a clearance provided in the ceiling member, wherein the clearance is sufficient to permit the product to traverse the product stop when so moved; and removing the packaged product from the device.

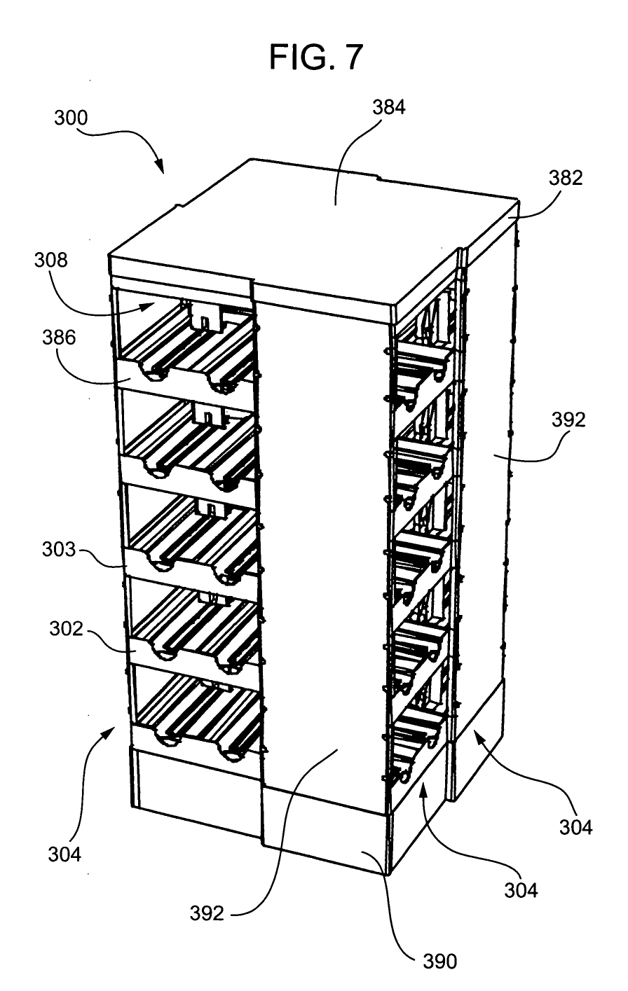

Turning to FIG. 7, there is illustrated another embodiment of a product dispensing device of the present invention configured as an upright stand 300. This stand may be used to display and dispense packaged products, such as DVDs, CDs and the like, in a retail environment. As with the other embodiments described herein, this embodiment is designed to limit the number of products that can be dispensed from the device at one time.

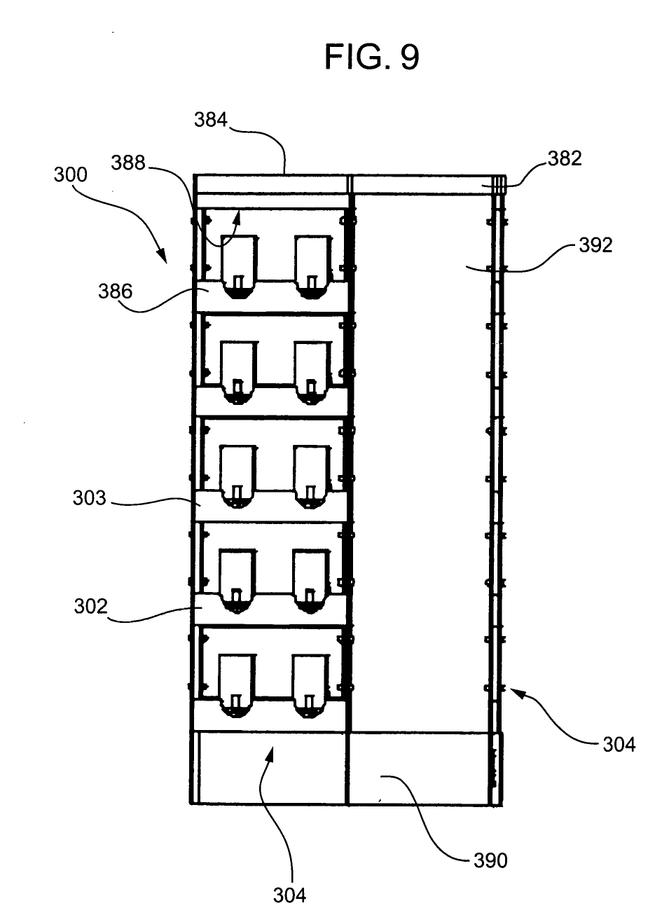

As illustrated in FIGS. 7, 8, and 9, the upright stand 300 is desirably prepared using a plurality of substantially identical trays, e.g., indicia 302, 303, arranged vertically in multiple stacks 304. In the illustrated embodiment, five parallel stacks 304 are included and arranged in a two-by-two configuration, though in other embodiments the total number of stacks may differ depending on the desired end use. Within each vertical stack 304, the trays 302, 303 are located parallel to and spaced vertically apart from each other to provide a path 308 for receiving the packaged products. Hence, where each stack 304 includes a plurality of vertically spaced trays, e.g., 302 and 303, a comparable number of vertically arranged paths 308 are provided for receiving the packed products.

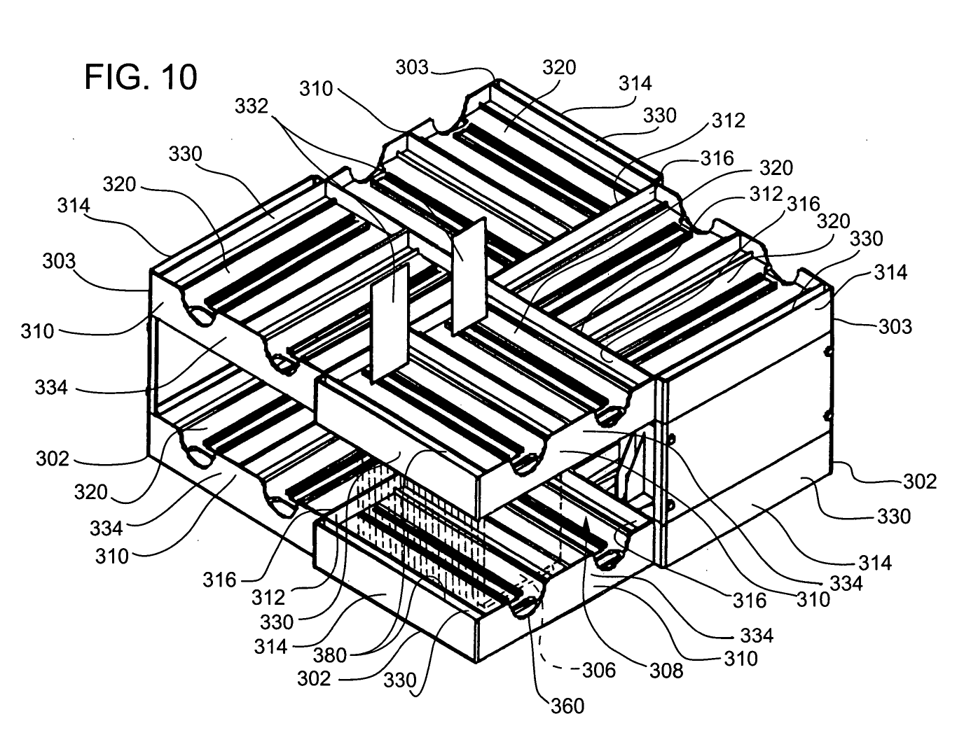

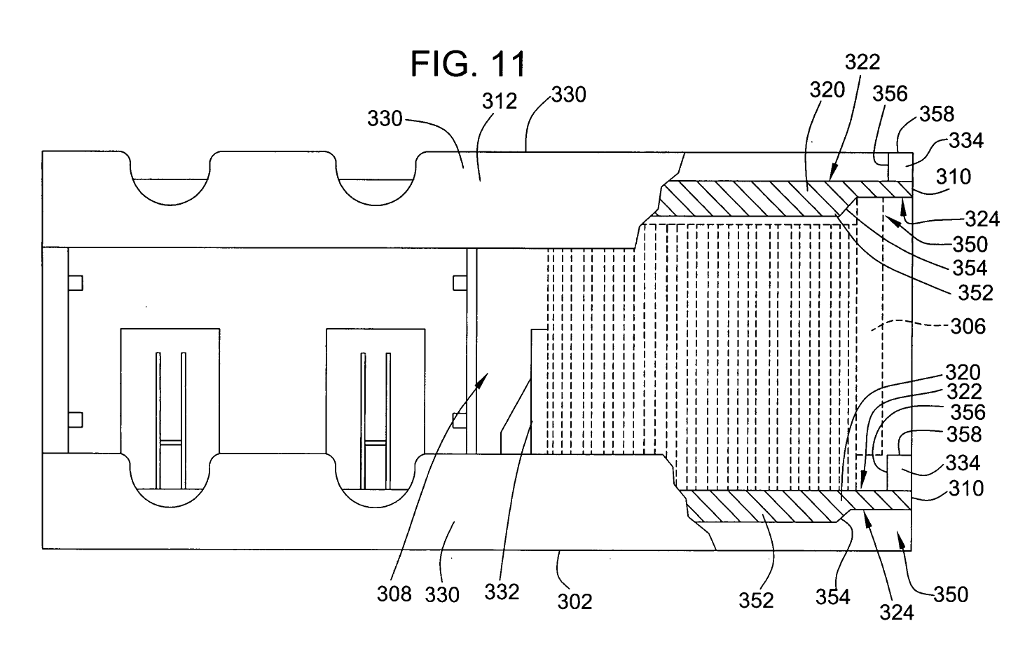

Referring to FIGS. 10 and 11, and to permit ease of description, there is illustrated two levels of vertically arranged trays. A series of first trays 302 (four in number) are arranged in a two-by-two configuration below a correspondingly arranged series of second trays 303 (also four in number), providing a plurality of product paths 308 therebetween. The trays may comprise any suitable material including, for example, a molded, relatively light-weight, thermoplastic or thermoset material. The trays of each level can be releasably interlocked together or, in other embodiments, integrally molded together.

Each tray 302, 303 on each level includes a dispensing end 310 corresponding to one edge and an opposing rearward end 312 corresponding to a opposite edge. To complete the shape of each tray, parallel first and second side edges 314, 316 extend between the dispensing end 310 and the rearward end 312. Within each two-by-two level, the trays 302, 303 are arranged so that the dispensing ends 310 are directed outwardly to permit ready access by a consumer, while the rearward edge 312 abuts the second side edge 316 of an adjacent tray.

As illustrated in FIG. 11, each tray 302 further includes a planar, horizontally oriented base member 320 having an upper base member surface 322 and a generally parallel lower base member surface 324. When the trays are arranged in a stack, the upper base member surface 322 of a first tray 302 is spaced below the lower base member surface 324 of a second tray 303. When placing the packaged products, designated as 306 and shown in phantom in FIG. 11, in the path 308 between the first and second trays 302, 303, the products are supported by the upper base member surface 322 of the first tray 302 oriented in a row directed toward the dispensing end 310. Accordingly, it will be appreciated that the distance between the base members 320 of the first and second trays 302, 303 should be at least equal to, and desirably greater than, the height of the packaged products 306.

Referring to FIGS. 10 and 11, to keep the products 306 within the path 308, it is desirable that each tray also include a vertically oriented peripheral wall 330 about the dispensing and rearward ends 310, 312 and first and second side edges 314, 316. The peripheral wall extends a predetermined distance perpendicularly beyond the upper and lower base member surfaces 320, 322. The peripheral walls 330 of the first and second trays 302, 303 partially surround the products supported by the upper base member surface 322 preventing removal except via the dispensing end 310.

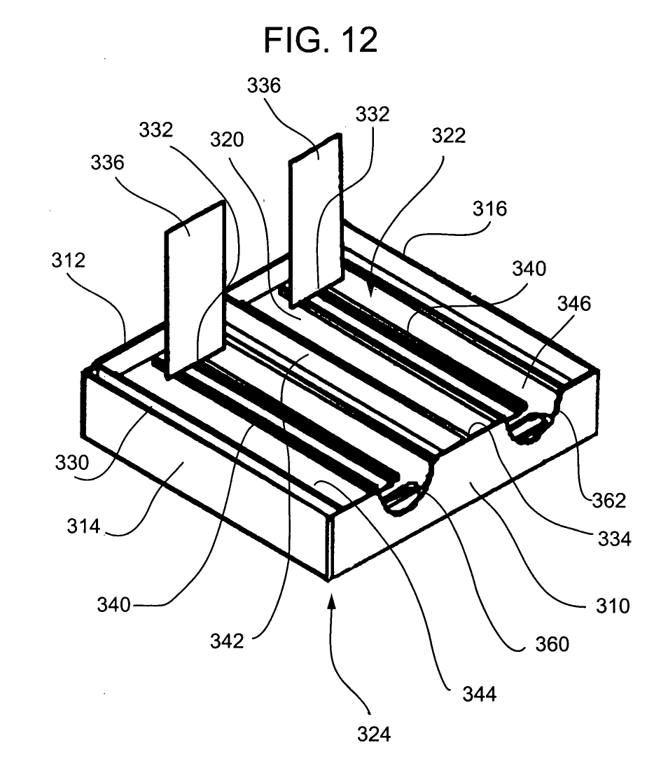

To maintain packaged products 306 at the dispensing end 310 for selection by a consumer, each tray 302, 303 also includes at least one biasing mechanism 332 that biases the products toward the dispensing end. Referring to the embodiment illustrated in FIG. 12, two biasing mechanisms are shown, with each biasing mechanism 332 including a reciprocally movable biasing plate 336 extending perpendicularly upwardly from the upper base member surface 322 and a spring (not shown). To guide the biasing plate, the upper base member surface 322 desirably includes parallel tracks 340 which extend generally between the dispensing end 310 and the rearward end 312. Catches, desirably located on the biasing plate 336, can engage the tracks 340 to assist in maintaining the desired directional movement of the biasing plate.

Forward movement of the products 306 is limited, however, by a portion of the peripheral wall 330 that extends along the dispensing end 310. This portion of the wall functions as a product stop 334, as described hereinabove.

In the illustrated embodiment of FIG. 12, the tray 324 is configured to accommodate two rows of products. To facilitate these rows, the tray 324 includes a dividing wall 342 projecting from the upper base member surface 322 between the dispensing end 310 and rearward end 312 that divides the base member 320 into first and second halves 344, 346. Each half 344, 346 may receive a row of products, each row being separated by the dividing wall 342. Moreover, each half 344, 346 includes a biasing mechanism 332 of the type described above for biasing the products toward the dispensing end.

Referring to FIG. 11, the trays illustrated therein are configured to limit the number of products 306 (shown in phantom) that can be removed via the dispensing end 310 during a single dispensing cycle. To accomplish this result, the trays are adapted to provide a clearance 350 at the dispensing end 310. To dispense a product 306, the product at the dispensing end 310 may be moved vertically upward into the clearance 350, thereby permitting the bottom of the product to be moved laterally so as to traverse the product stop 334.

To provide the clearance 350, an embossment 352 may be formed on the lower base member surface 322 of the second tray 330 that projects toward the first tray 302. In the illustrated embodiment, the embossment 352 is configured as a downward projecting, elongated rail or wall extending from the rearward end 312 towards the dispensing end 310. The embossment 352 effectively reduces the height of the path preferably such that the vertical distance between the embossment and the upper base member surface 322 of the first tray 302 is slightly greater than the height of the product 306. The embossment 352 terminates at a terminal edge 354 located rearward of the dispensing end 310 and short of the product stop 334, thereby creating a clearance 350. The dimensions of the clearance 350 are such that the vertical distance between lower base member surface 324 of the second tray 303 and the top of the product stop 334 is at least equal to, and desirably slightly greater than, the predetermined height of the packaged product 306.

To dispense a product 306 biased against the inner surface of the product stop 334, the product is first moved vertically upward into the clearance 350. To limit the number of products 306 that can be dispensed at one time, the distance between the inner surface 356 of the product stop 334 and the terminal edge 354 of the embossment 352 is desirably no greater than about twice the thickness of the packaged product, and preferably no more than about 1-½ times, and more preferably no more than equal to, the thickness of the product. Thus, and preferably, only two products 306 and, more preferably only one product, may be vertically moved into and reside at least partially within the clearance 350 at one time. To assist in aligning the product within the clearance, the terminal edge 354 of the embossment 352 may desirably slant towards the rearward end 312. After the bottom of the package product has cleared the top edge 358 of the product stop 334, the product may be moved laterally forward to traverse the product stop, and may then be removed from the dispensing device 100. As a packaged product is removed from the dispensing device 300, the biasing mechanism 332 will laterally move the next product in the row forward toward the dispensing end 310 for selection.

As illustrated in FIGS. 10 and 12, to assist in moving the product 306 within the device 300, a notch 360 may desirably be disposed through the product stop 334 and partly into the upper base member surface 322 of the base member 320. The notch 360 is dimensioned to allow a consumer to insert a finger underneath a product 306 at the dispensing end 310, and push the product vertically upwards into the clearance. In the embodiments where each tray 302 is configured to accommodate two rows of products, first and second notches 360, 362 may be disposed into the product stop 334, each notch corresponding to the first and second halves 344, 346.

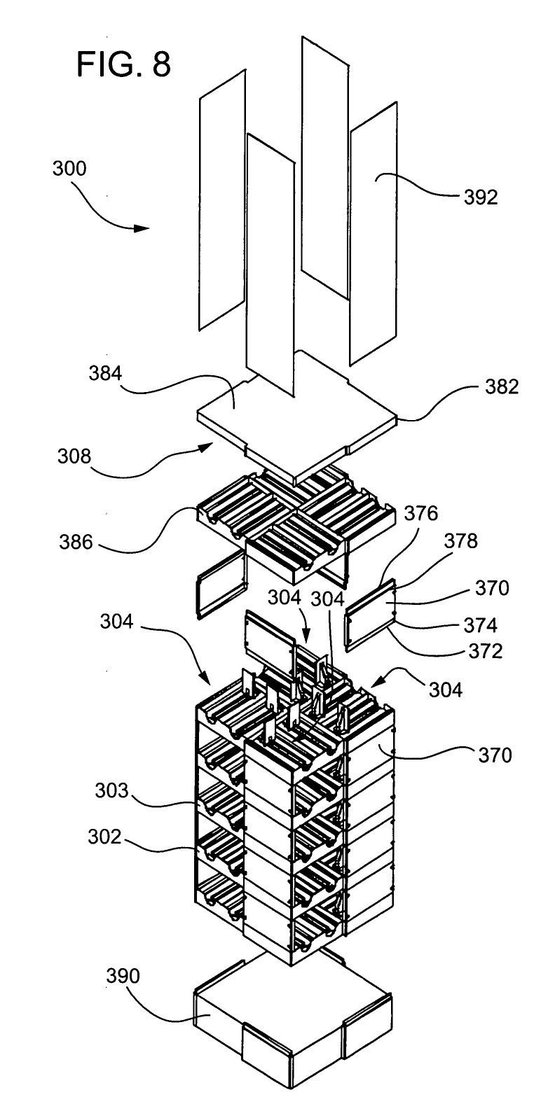

To further inhibit unintended removal of products, as illustrated in FIG. 8, the stand 300 may also include a plurality of side panels 370 extending between the trays 302, 303. Each side panel 370 is desirably a planar structure having a first tongue 372 corresponding to a lower edge 374 and a second tongue 376 corresponding to the upper edge 378. Referring to FIG. 10, the first and second tongues are preferably adapted to be received in dimensionally corresponding grooves 380 disposed along the first edges 314 of each tray 302, 303. When assembled, the side panels 370 extend generally between the dispensing end 310 and the rearward end 312 thereby blocking side access to the products 306 residing in the path 308. Additionally, the side panels 370 may function to maintain the first and second trays 302, 303 in the spaced arrangement that assists in defining the path 308.

Referring again to FIGS. 7, 8, and 9, a cap member 382 is located at the uppermost level of the vertical stand 300. The cap member 382 is generally square with a planar top surface 384 spaced above the vertically highest level of trays included within the stand 300. To enable the uppermost level of trays 386 to dispense a limited number of products in the above-described manner, it will be appreciated that the lower surface 380 of the cap member 382 must be formed similarly to the lower base member surface 324 of the trays, e.g., including an embossment and a clearance.

The stand 300 may, if desired, further include a foot member 390 located at the lowermost level. The foot member 390 is designed to assist in supporting the vertically stacked trays, e.g., 302, 303, and, as will be appreciated by those of skill in the art, may be configured to permit the stand 300 to be rotated about a vertically-oriented axis to assist in consumer selection of the products. To enhance the aesthetic appearance of the stand 300, a plurality of elongated panels 392 may also be included, these panels extending from the cap member 384 to the base member 390, and attached along the side panels 370 between the trays. The elongated panels 392 may, if desired, include advertising or other artistic indicia.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A display and dispensing device including a dispensing end, and a rearward end for a product having a predetermined height and thickness, the device comprising:
a base member extending between the dispensing end and the rearward end, the base member including an upward projecting product stop at the dispensing end the base member further including a notch disposed therethrough proximate the dispensing end to facilitate product removal by a purchaser;
a ceiling member including a ceiling panel above the base member, the ceiling panel and base member defining a path between the dispensing end and the rearward end for lateral product movement; and
a biasing mechanism biased toward the dispensing end, the biasing mechanism biasing a product within the device against an inner surface of the product stop;
wherein the distance between the ceiling member and base member defines a clearance which is sufficient to permit the product to traverse the stop when the product is moved vertically within the device, thereby allowing the product to be removed from the device.

2. The device of claim 1, wherein the ceiling member extends at least coextensively with the inner surface of the product stop.

3. The device of claim 1, further comprising at least one side wall located between the base member and ceiling member.

4. The device of claim 3, further comprising at least two side walls, wherein the side walls are adapted to permit product removal only through the dispensing end of the device.

5. The device of claim 1, wherein the ceiling member further includes at the dispensing end a canopy providing the clearance above the product stop for vertical product movement that is at least equal to the product height, the clearance extending above the ceiling panel and traversing the product stop.

6. The device of claim 5, wherein the canopy includes a first edge and a second edge, the first edge being joined to the ceiling panel rearward of the product stop and the second edge located forward of the product stop.

7. The device of claim 6, wherein the lateral distance between the inner surface of the product stop and the first edge of the canopy is less than twice the thickness of the product.

8. The device of claim 7, wherein the canopy includes a surface curving generally away from the base member, the canopy further including first and second side panels extending generally perpendicular along either side of the curved surface.

9. The device of claim 6, wherein the first edge is located about ½ to about 3 inches rearward of the product stop.

10. The device of claim 9, wherein the second edge is located about ½ to about 3 inches forward of the product stop.

11. The device of claim 10, wherein the curved surface is generally Quonset-shaped.

12. The device of claim 1, wherein the base member and the ceiling member are adjustably joined together to increase or decrease the vertical distance therebetween.

13. The device of claim 12, wherein the base member includes at least one upright having a plurality of vertically aligned apertures disposed therein, and the ceiling member includes at least one downward extending leg having a protrusion, the protrusion sized for reception in an aperture.

14. The device of claim 1, wherein the notch is located and dimensioned to permit a finger of a purchaser to move a product located adjacent the inner surface of the product stop both vertically and laterally, thereby traversing the product stop and allowing the product to be removed from the device.

15. The device of claim 14, wherein the product stop includes a slot disposed therethrough, the slot intersecting the notch.

16. The device of claim 1, wherein the biasing mechanism includes a biasing plate generally perpendicular with the base member and a spring.

17. The device of claim 16, wherein the base member includes a track extending generally between the dispensing end and the rearward end and the biasing plate includes at least one catch slidably engaging the track.

18. The device of claim 1, wherein the base member and ceiling panel are parallel.

19. The device of claim 1, wherein the product stop is perpendicular to the ceiling panel.

20. The device of claim 1, wherein the base member and ceiling member are comprised of a transparent thermoplastic or thermoset material.

21. A display and dispensing device including a dispensing end and a rearward end for a product having a predetermined height and thickness, the device comprising:
a base member extending between the dispensing end and the rearward end, the base member including an upward projecting product stop at the dispensing end;
a ceiling member including a ceiling panel above the base member and a canopy located at the dispensing end which includes first and second edges, the first edge being joined to the ceiling panel rearward of the product stop and the second edge located forward of the product stop, wherein the ceiling panel and base member define a path between the dispensing end and the rearward end for lateral product movement; and
a biasing mechanism biased toward the dispensing end, the biasing mechanism biasing a product within the device against an inner surface of the product stop;
wherein the canopy provides a clearance above the product stop, the clearance being sufficient to permit the product to traverse the product stop when the product is moved vertically within the clearance, thereby allowing the product to be removed from the device.

22. The device of claim 20, wherein the canopy includes a surface curving generally away from the base member.

23. The device of claim 21, wherein the lateral distance between an inner surface of the product stop and the first edge of the canopy is less than twice the thickness of the product.

24. The device of claim 22, further comprising at least two side walls, and wherein the canopy includes a surface curving generally away from the base member, the first edge is located about ½ to about 3 inches rearward of the product stop, and the second edge is located about ½ to about 3 inches forward of the product stop.

25. The device of claim 20, wherein the base member and the ceiling member are adjustably joined together to increase or decrease the vertical distance therebetween.

26. The device of claim 25, wherein the base member includes at least one upright having a plurality of vertically aligned apertures disposed therein, and the ceiling member includes at least one downward extending leg having a protrusion, the protrusion sized for reception in an aperture.

27. A device for dispensing and displaying a package product comprising:
a base member having a dispensing end and an opposite rearward end, the base member including an upward projecting product stop at the dispensing end;
a ceiling member above the base member, the ceiling member extending at least coextensive with an inner surface of the product stop,
wherein the base member and ceiling member are arranged to define a clearance above the product stop that is sufficient to permit the product to traverse the stop when the product is moved vertically within the device, thereby allowing the product to be removed from the device.

28. A method of dispensing a packaged product having a predetermined height and thickness comprising:
providing a device including a base member and an opposing ceiling member extending between a dispensing end and a rearward end, the base member having an upward projecting product stop at the dispensing end, and the ceiling member having a ceiling panel and a canopy portion, the canopy portion extending at least coextensive with the product stop;
laterally biasing a packaged product located between the base member and the ceiling member against an inner surface of the product stop;
vertically moving a packaged product into a clearance provided by the canopy portion of the ceiling member, wherein the clearance is sufficient to permit the product to traverse the product stop when so moved; and
removing the packaged product from the device.

29. A stack for dispensing and displaying a packaged product having a predetermined height and thickness, the stack comprising:
a plurality of trays arranged generally vertically in the stack, each tray comprising a dispensing end, an opposite rearward end, a base member having an upper surface and a lower surface, and a product stop projecting upward from the upper surface of the base member proximate to the dispensing end, the plurality of trays arranged so that the upper base member surface of a first tray is spaced below the lower base member surface of a second tray to provide a path for lateral movement of a product, the distance between the upper base member surface of the first tray and the lower base member surface of the second tray being selected to provide clearance sufficient to permit the product to traverse the product stop when the product is moved vertically within the tray, thereby allowing the product to be removed from the stack.

30. The stack of claim 29, further comprising a first biasing mechanism located between the first and second trays and biased toward the dispensing end.

31. The stack of claim 30, wherein the first biasing mechanism includes a biasing plate generally perpendicular with the upper base member surface of the first tray and a spring.

32. The stack of claim 29, wherein the lower base member surface of the second tray includes an embossment projecting towards the first tray, the embossment located rearward from the product stop.

33. The stack of claim 32, wherein the lateral distance between the embossment and the product stop is about twice the thickness of the product or less.

34. The stack of claim 29, wherein the base member of the first tray includes at least a first notch which permits the finger of a purchaser to move product located adjacent the stop both vertically and laterally, thereby traversing the product stop and allowing the product to be removed from the first tray.

35. The stack of claim 34, wherein the product stop includes at least one slot disposed therethrough, the slot intersecting with the notch.

36. The stack of claim 34, wherein the depth of the notch in the base member is about twice the thickness of the product or less.

37. The stack of claim 36, wherein the base member of the first tray includes a first and second notch, the second notch arranged in side-by-side relation to the first notch.

38. The stack of claim 37, further comprising a second biasing mechanism, the first biasing mechanism being aligned with the first notch and the second biasing mechanism being aligned with the second notch.

39. The stack of claim 29, wherein the upper base member surface of the first tray includes a first track and a second track, the first and second tracks extending generally between the dispensing end and the biasing end, the first track aligned with the first notch and the second track aligned with the second notch.

40. The stack of claim 39, wherein the first and second biasing mechanisms each include a respective first and second catch, the first and second catches engaging the respective first and second tracks.

41. The stack of claim 40, wherein the lower base member surface of the second tray further comprises a canopy providing a clearance for vertical product movement to permit the product adjacent the stop to traverse the stop and allow the product to be removed from the stack.

42. The stack of claim 41, wherein the canopy is partly disposed through the dispensing end.

43. The stack of claim 29, further comprising at least one side panel attached to the first and second trays and extending generally between the dispensing end and the rearward end.

44. A stand for displaying and dispensing a product having a predetermined height and thickness, the cube comprising:
a plurality of generally vertical stacks, each stack including a plurality of trays each comprising a dispensing end, an opposite rearward end, a base member having an upper surface and an lower surface, and a product stop projecting upward from the upper surface of the base member proximate the dispensing end, the plurality of trays arranged in the stacks so that the upper base member surface of a first tray is spaced-below the lower base member surface of a second tray to provide a path for lateral movement of a product, the distance between the upper base member surface of the first tray and the lower base member surface of the second tray being selected to provide clearance sufficient to permit the product to traverse the product stop when the product is moved vertically within the tray, thereby allowing the product to be removed from the stand.

45. The stand of claim 44, wherein the lower base member surface of the second tray includes an embossment projecting towards the first tray, the embossment located rearward from the product stop.

46. The stand of claim 45, wherein the lateral distance between the embossment and the product stop is about twice the thickness of the product or less.

47. The stand of claim 44, wherein the stand includes four stacks arranged in a two-by-two configuration.

48. The stand of claim 47, wherein each tray has a first side edge and a second side edge, the first and second side edges extending between the dispensing end and the rearward edge.

49. The stand of claim 48, wherein the four stacks are arranged so that the rearward edge of at least one tray is adjacent a first side edge of another tray.

50. The stand of claim 44, further comprising a first biasing mechanism located between first and second trays and biased toward the dispensing end.

51. The stand of claim 50, wherein the first biasing mechanism includes a biasing plate generally perpendicular with the upper base member surface of the first tray and a spring.

52. The stand of claim 51, wherein the first tray includes at least a first notch disposed into the dispensing edge and the upper base surface which permits the finger of a purchaser to move product located adjacent the stop both vertically and laterally, thereby traversing the product stop and allowing the product to be removed from the first tray.

53. The stand of claim 52, wherein the base member of the first tray includes a second notch disposed into the dispensing edge and the upper base surface, the second notch arranged in a side-by-side relation to the first notch.

54. The stand of claim 53, further comprising a second biasing mechanism, the first biasing mechanism being aligned with the first notch and the second biasing mechanism being aligned with the second notch.

55. A stack for dispensing and displaying a packaged product having a predetermined height and thickness, the stack comprising:
a plurality of trays arranged generally vertically in the stack, each tray comprising a dispensing end, an opposite rearward end, a base member having an upper surface and a lower surface, the lower base member surface including an embossment, and a product stop projecting upward from the upper surface of the base member proximate to the dispensing end, the plurality of trays arranged so that the upper base member surface of a first tray is spaced below the lower base member surface of a second tray to provide a path for lateral movement of a product, the distance between the upper base member surface of the first tray and the lower base surface of the second tray being selected to provide clearance sufficient to permit the product to traverse the product stop when the product is moved vertically within the tray, thereby allowing the product to be removed from the stack, the plurality of trays further arranged so that the lower base member surface extends at least coextensively with an inner surface of the product stop and the embossment is located rearward of the inner surface of the product stop to define the path.

56. The device of claim 1 wherein the clearance is sized to allow two or fewer products to traverse the product stop at a time, the device comprising:
a base member extending between the dispensing end and the rearward end, the base member including an upward projecting product stop at the dispensing end;
a ceiling member including a ceiling panel above the base member and a canopy located at the dispensing end which includes first and second edges, the first edge being joined to the ceiling panel rearward of the product stop and the second edge located forward of the product stop, wherein the ceiling panel and base member define a path between the dispensing end and the rearward end for lateral product movement; and
a biasing mechanism biased toward the dispensing end, the biasing mechanism biasing a product within the device against an inner surface of the product stop;
wherein the canopy provides a clearance above the product stop, the clearance being sufficient to permit the product to traverse the product stop when the product is moved vertically within the clearance, thereby allowing the product to be removed from the device.

57. The device of claim 1 wherein the clearance is sized to allow only one product to traverse the product stop at a time, the device comprising:
a base member extending between the dispensing end and the rearward end, the base member including an upward projecting product stop at the dispensing end;
a ceiling member including a ceiling panel above the base member and a canopy located at the dispensing end which includes first and second edges, the first edge being joined to the ceiling panel rearward of the product stop and the second edge located forward of the product stop, wherein the ceiling panel and base member define a path between the dispensing end and the rearward end for lateral product movement; and
a biasing mechanism biased toward the dispensing end, the biasing mechanism biasing a product within the device against an inner surface of the product stop;
wherein the canopy provides a clearance above the product stop, the clearance being sufficient to permit the product to traverse the product stop when the product is moved vertically within the clearance, thereby allowing the product to be removed from the device.

58. The device of claim 1 wherein the clearance is sized to allow two or fewer products to traverse the product stop at a time, the base member including an upward projecting product stop at the dispensing end;
a ceiling member above the base member, the ceiling member extending at least coextensive with an inner surface of the product stop,
wherein the base member and ceiling member are arranged to define a clearance above the product stop that is sufficient to permit the product to traverse the stop when the product is moved vertically within the device, thereby allowing the product to be removed from the device.

59. The device of claim 1 wherein the clearance is sized to allow only one product to traverse the product stop at a time, comprising:
providing a device including a base member and an opposing ceiling member extending between a dispensing end and a rearward end, the base member having an upward projecting product stop at the dispensing end, and the ceiling member having a ceiling panel and a canopy portion, the canopy portion extending at least coextensive with the product stop;
laterally biasing a packaged product located between the base member and the ceiling member against an inner surface of the product stop;
vertically moving a packaged product into a clearance provided by the canopy portion of the ceiling member, wherein the clearance is sufficient to permit the product to traverse the product stop when so moved; and
removing the packaged product from the device.
